(19) United States
(12) Patent Application Publication
(10) Pub. No.: US 2012/0279503 A1
(43) Pub. Date: Nov. 8, 2012

(54) Breathing Apparatus With Ultraviolet Light Emitting Diode

(76) Inventors: Ling Zhou, Dublin, CA (US); Ying Gao, Beijing (CN)

(21) Appl. No.: 13/230,262

(22) Filed: Sep. 12, 2011

(30) Foreign Application Priority Data
May 3, 2011 (CN) 201110112161.6

(51) Int. Cl. A62B 18/02

(52) U.S. Cl. 128/205.27

(57) ABSTRACT

A breathing apparatus according to embodiments of the invention includes a facemask portion sized to cover a lower portion of a wearer's face. The facemask portion includes a flow chamber defined by a support layer and a cover. The flow chamber has a first opening disposed near a first end of the flow chamber and a second opening disposed near a second end of the flow chamber. At least one light emitting diode configured to emit light having a peak wavelength in the ultraviolet range is disposed between the first opening and the second opening in the flow chamber.

### BACKGROUND

1. Field of Invention

The present invention relates to a breathing apparatus that uses ultraviolet light emitting diodes to reduce risk from airborne pathogens.

2. Description of Related Art

Acute respiratory infection (ARI), which causes millions deaths every year, is the number one cause of death in the developing world, and number three cause of death worldwide. In the event of an ARI pandemic or other emerging respiratory disease such as severe acute respiratory syndrome (SARS), measures are preferably taken immediately to reduce the infection rate, rather than wait for a targeted vaccine or antiviral drug to be developed. Wearing a facemask is a widely accepted, non-pharmaceutical method to reduce the risk of respiratory infection.

Examples of common facemasks include disposable surgical facemasks and N95 respirators. This type of facemask reduces transmission of airborne pathogens by preventing a person from directly touching his nose and mouth with dirty hands and by containing large liquid droplets expelled during sneezing or coughing. This type of facemask is unable to disinfect the air being inhaled or exhaled, and typically cannot block airborne viruses, most of which are smaller than 0.3 microns and can pass through the pores in the fabrics of this type of facemask. In addition, because the main air passageway of the facemask is blocked by one or more layers of fabric, this type of facemask is generally uncomfortable to wear, which may discourage people from using facemasks. Furthermore, if the mask is not face-fitted, a significant amount of air can leak through the periphery of the mask, significantly reducing the mask's effectiveness and leading to other inconveniences such as fogging of lenses in cold weather for eye-glass wearers from leakage of moist air.

FIG. 1 illustrates a chemical and biological protection mask described in more detail in US 2010/0132715. The gas mask assembly 2 generally comprises a molded mask portion 10 containing a frontal one-way exhalation valve 20 and one or more adjacent inhalation apertures 12. The inhalation aperture 12 is equipped with a push-and-twist receptacle 14. A UV-illumination tube 50 is interposed between the inhalation aperture 12 and a filter assembly 40, which may provide mechanical filtration capabilities, such as HEPA-type or charcoal filters. The UV illumination tube 50 is a short multi-part cylinder, approximately 2-5″, with mating push-and-twist receptacle/seats at each end for seating the filter assembly 40 and insertion into receptacle 14 of mask 10. The UV illumination tube 50 further comprises a cylindrical aluminum outer shell, and a cylindrical plastic insert that seats a plurality of elongate axially-aligned circuit boards each carrying a plurality of surface-mounted LED UV lights disposed inwardly toward the centerline of the tube 50. The UV illumination tube 50 is centrally unobstructed and incoming air from filter assembly 40 remains free to pass into the inhalation aperture 12 of the mask 10. While passing through the tube's length, the air is illuminated with high-intensity shortwave ultraviolet light from the LEDs and is thereby fully filtered and irradiated for combined chemical and biological protection. Power for the LEDs is derived from an on-board battery which may be built into the UV illumination tube 50 or the mask 10 (requiring slide-connectors along the lip of the tube 50), and/or from a solar cell likewise mounted on the UV illumination tube 50 or the mask 10. Preferably, an on/off detent switch 52 for the LEDs is provided on the tube 50 as well.

### SUMMARY

A breathing apparatus according to embodiments of the invention includes a facemask portion sized to cover a lower portion of a wearer's face. The facemask portion includes a flow chamber defined by a support layer and a cover. The flow chamber has a first opening disposed near a first end of the flow chamber and a second opening disposed near a second end of the flow chamber. At least one light emitting diode configured to emit light having a peak wavelength in the ultraviolet range is disposed between the first opening and the second opening in the flow chamber.

### BRIEF DESCRIPTION OF THE DRAWINGS

FIG. 1 illustrates a prior art chemical and biological protection mask.

FIG. 2 illustrates a breathing apparatus according to embodiments of the invention.

FIG. 3 is an exploded side view of the facemask illustrated in FIG. 2.

FIG. 4 illustrates an example of a support layer and air flow through a flow chamber in the facemask illustrated in FIG. 2.

FIG. 5A illustrates an alternative example of a support layer and air flow through a flow chamber in the facemask illustrated in FIG. 2. FIG. 5B illustrates an individual reflective chamber.

FIG. 6 illustrates electrical components suitable for controlling the UV LEDs in the breathing apparatus illustrated in FIG. 2.

FIG. 7 illustrates one example of operation of the breathing apparatus of FIG. 2. FIG. 7 is a plot of air pressure and UV LED drive current as a function of time.

### DETAILED DESCRIPTION

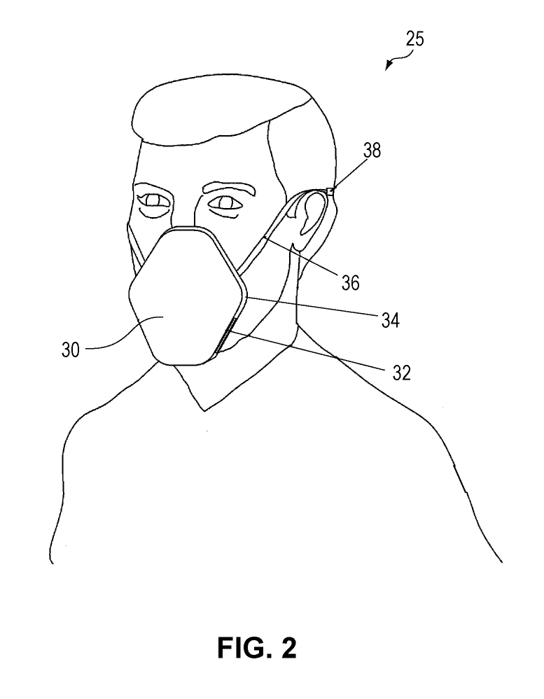

FIG. 2 illustrates a breathing apparatus according to embodiments of the invention. Breathing apparatus 25 includes a facemask 30 which is sized and shaped to fit over a person's face, covering the mouth and/or nose of the wearer. Facemask 30 may be rigid or flexible and may include a flexible sealing ring 34 around the outside which forms a partial or full seal with the wearer's face. An opening 32 on at least one side of facemask 30 allows ambient air to flow into the facemask when the wearer inhales and allows exhaled air to flow out of the facemask when the wearer exhales. A string 36 or other suitable structure holds the facemask on the wearer's face. In some embodiments, the string 36 includes a power cord which connects ultraviolet (UV) LEDs in facemask 30 to a power source such as a rechargeable or disposable battery pack 38 attached to string 36 and worn behind the wearer's head.

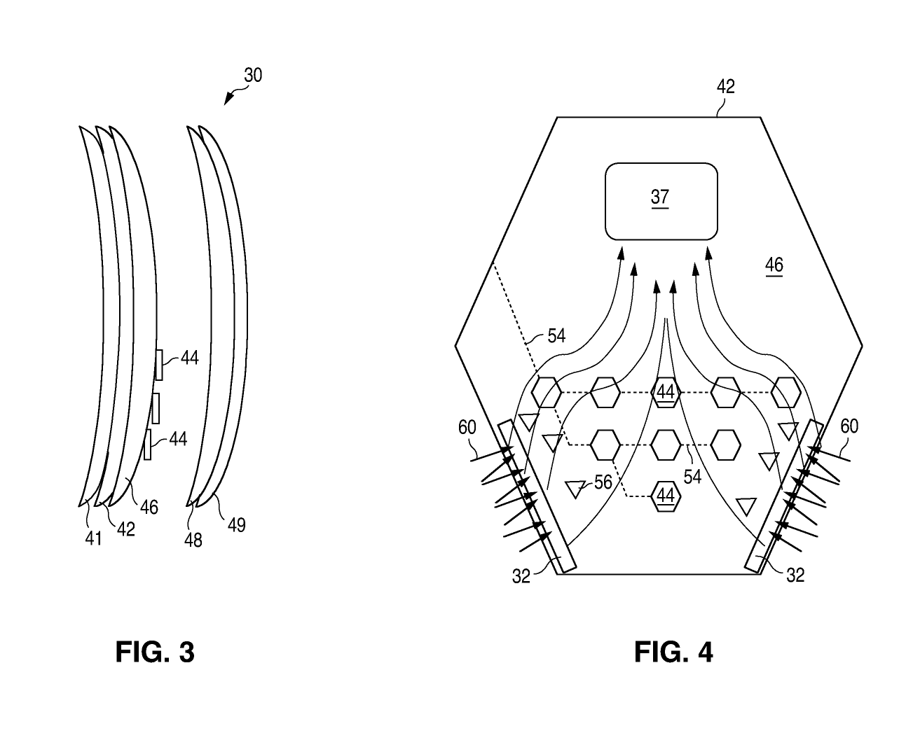

FIG. 3 is an exploded side view of facemask 30 of FIG. 2. A flow chamber in facemask 30 is formed by a support layer 42 and an outer shell 49. One example of a support layer 42 is illustrated in a plan view in FIG. 4. The support layer 42 may be, for example, a rigid or flexible circuit board on which one or more UV LEDs 44 are mounted. Wiring 54 may be formed on support layer 42 to electrically connect UV LEDs 44 to each other and to a power source such as a battery pack. Support layer 42 has an opening 37 located proximal to the wearer's nose and/or mouth, through which the wearer inhales and exhales. The surface of support layer 42 that forms a wall of the flow chamber may be coated or covered with any suitable UV-reflective material 46. Examples of suitable UV-reflective materials include but are not limited to metals or metal alloys, such as aluminum or palladium; oxides such as SiO₂ or Al₂O₃; or metal-oxide hybrids. The reflective coating 46 may be plated, sputtered, or evaporated directly on support layer 42, or the reflective coating may be a foil or a film attached to the surface of support layer 42 that forms the wall of the flow chamber.

The outer shell 49 of the flow chamber may be a rigid or flexible cover, such as a plastic or rubber cover. The surface of outer shell 49 that forms a wall of the flow chamber may be coated or covered with a UV-reflective material 48, which may be any of the materials formed by the methods described above in reference to reflective coating 46 on support layer 42.

The surface of the facemask 30 that touches the wearer's face may be covered with an optional fabric layer 41. The same or a different optional fabric layer may cover openings 32, for example to mechanically filter air in dusty environments. The same or a different optional fabric layer may cover opening 37, for example to contain liquid such as saliva or nasal fluid. Any of the optional fabric layers may be disposable or washable.

One or more UV LEDs 44 are located within the flow chamber. UV LEDs 44 may be any suitable devices that emit radiation at a wavelength that is able to disinfect the air flowing through the flow chamber. In some embodiments, UV LEDs 44 emit radiation with a peak wavelength less than 300 nm. In some embodiments, UV LEDs 44 are configured to emit light over broad angles, for example in a cone of at least 120°, such that UV radiation is emitted into as much of the volume in the flow chamber as possible. The emission pattern may be controlled through optics, lenses, or reflectors connected to the device structure of UV LEDs 44 or to packages in which the device structure of UV LEDs 44 are disposed, as is known in the art. UV LEDs 44 are disposed within the flow chamber and surrounded by reflective materials 46 and 48, such that little or no UV radiation is able to escape the flow chamber. The wearer of the breathing apparatus and the public are therefore exposed to little or no UV radiation from facemask 30.

FIG. 4 illustrates air flowing through the inside of the flow chamber. When the wearer inhales, ambient air 60 is drawn into the flow chamber through openings 32 located on a part of facemask 30 that is far from the wearer's nose and mouth. For example, openings 32 may be located on one or both sides of a lower part of the facemask 30, as illustrated in FIG. 4, and/or on the bottom of the facemask 30. Though two openings 32 are illustrated in FIG. 4, the shape, number, and size of openings 32 is not critical. The larger the openings 32, the easier it is to breathe through breathing apparatus 25. Openings 32 may be formed in support layer 42, in outer shell 49, or may be positioned at a seam between support layer 42 and outer shell 49.

Air 60 drawn in through openings 32 is drawn by the wearer's breathing toward one or more openings 37 located proximal to the wearer's nose and mouth. The air flows over UV LEDs 44 which are placed between the openings 32 to the outside and the opening 37 to the wearer's nose and mouth. Any pathogens in the air are killed by exposure to radiation emitted by UV LEDs 44, such that the air is disinfected by the radiation emitted by UV LEDs 44. Radiation emitted by UV LEDs 44 is reflected by reflective materials 46 and 48 such that all or nearly all of the flow chamber is filled with UV radiation. Accordingly, little or no air passes through the flow chamber without being exposed to UV radiation.

In some embodiments, one or more optional vanes or other structures 56 to create turbulence are disposed in the flow chamber, for example near openings 32 as illustrated in FIG. 4. Structures 56 mix the incoming air 60 and prevent laminar flow of the air, which may (1) effectively lengthen the trajectory of air within the flow chamber, and (2) allow air to pass closer to the surface of the LEDs where the radiation has the highest intensity, causing more exposure to stronger UV radiation, which may result in purer air. Alternatively, the flow chamber can be divided into several serpentine passages to extend the distance air must travel before reaching opening 37, causing more exposure to UV radiation, which may result in purer air. Serpentine passageways may be formed by forming passageway walls on one or both of support layer 42 and outer shell 49, such that when support layer 42 and outer shell 49 are pressed together to form facemask 30, sealed or nearly sealed passageways are formed.

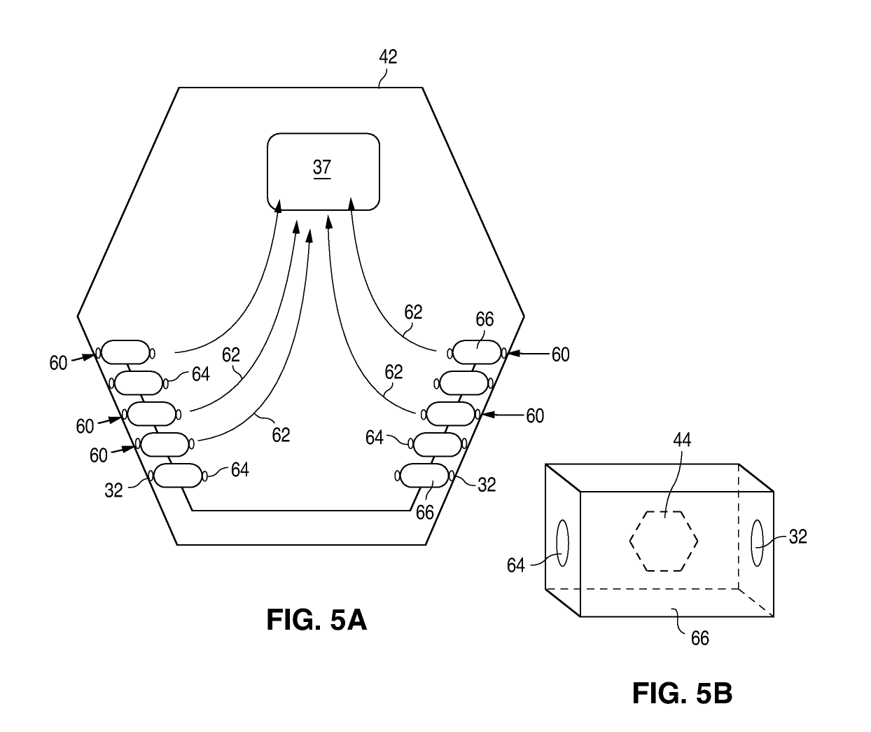

FIG. 5A illustrates an alternative support layer 42. Instead of UV LEDs 44 being mounted directly on support layer 42 as in FIG. 4, UV LEDs 44 are disposed in individual reflective chambers 66. An individual reflective chamber is illustrated in FIG. 5B. When the wearer inhales, ambient air is drawn from the outside not through two large openings 32 as illustrated in FIG. 4, but through small openings 32 associated with each reflective chamber 66. The walls of reflective chamber 66 may be coated with reflective material, as described above in reference to support layer 42 and outer shell 49, shown in FIGS. 3 and 4. Purified air exits each reflective chamber 66 through an opening 64 in a side of each chamber 66 opposite the opening 32 through which ambient air 60 enters each chamber. Purified air 62 is drawn toward opening 37 by the wearer's breathing.

In some embodiments, an optional sensor such as a pressure sensor, flow sensor, or valve senses the direction of the airflow and therefore distinguishes the stage of the breathing cycle. One or more sensors may be placed, for example, near openings 32, near openings 37, or near both openings 32 and 37. Examples of suitable optional sensors include air flow meters or pressure sensors that are commercially available and used in devices such as spirometers and artificial lungs. UV LEDs 44 can be turned on or off depending on the stage of the breathing cycle. For example, for a wearer who is healthy, UV LEDs 44 can optionally be turned on only during the inhaling part of the breathing cycle, such that only inhaled air is purified. For a wearer who is sick, UV LEDs 44 can optionally be turned on only during the exhaling part of the breathing cycle, such that only exhaled air is purified. Activating UV LEDs 44 during only part of the breathing cycle may reduce the battery consumption of breathing apparatus 25.

In some embodiments, the same or an additional optional sensor such as a differential pressure sensor or flow sensor is disposed on one end of the flow chamber, for example over openings 32 or opening 37. The optional sensor senses the pressure or flow rate of the air passing through the flow chamber. The drive current of UV LEDs 44 may be adjusted in response to information detected by the optional sensor. For example, when breathing is rapid and labored, such as when the wearer is physically exerted (for example, a running paramedic), the current supplied to UV LEDs 44 can be increased proportionally with the airflow, increasing the power emitted by UV LEDs 44 to maintain the effectiveness of the disinfection reaction. When the wearer is resting peacefully (for example, a physician at her desk), the current supplied to UV LEDs 44 can be reduced to reduce battery consumption and potentially increase the lifetime of UV LEDs 44. In some embodiments, when the optional sensor indicates that full power is not needed, only some UV LEDs 44 or only portions of each UV LED 44 may be activated.

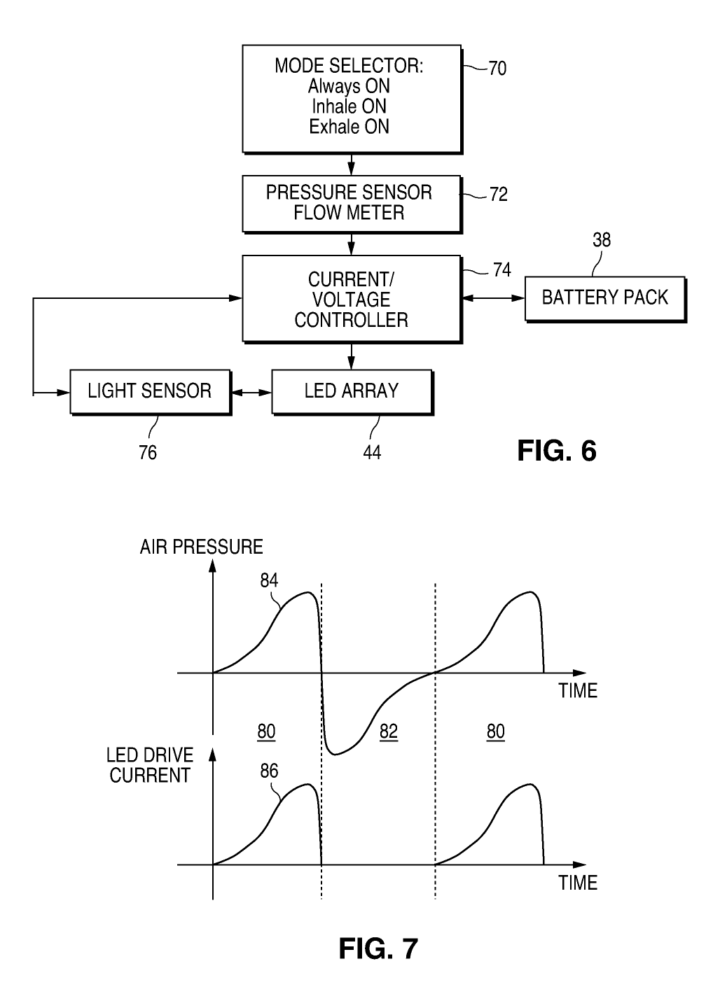

FIG. 6 illustrates an example of electrical components for a control system for breathing apparatus 25. An optional mode selector 70 determines whether UV LEDs 44 are always on, are activated only during the inhale portion of the breathing cycle, or are activated only during the exhale portion of the breathing cycle. Mode selector 70 may be, for example, a user-activated switch. An optional sensor 72 such as a pressure sensor, flow meter, or valve may determine whether the wearer is inhaling or exhaling, and/or may determine the pressure and/or flow rate of air through the flow chamber. Information from mode selector 70 and sensor 72 may be provided to current/voltage controller 74, which supplies current to the array of UV LEDs 44 based on the information. Power is supplied to controller 74 by power source 38, which may be, for example, the battery pack illustrated in FIG. 2. An optional UV sensor 76 may indicate to controller 74 how much radiation is emitted from UV LEDs 44, and/or whether the UV LEDs 44 are in working order. UV sensor 76 may provide an alert when radiation emitted by UV LEDs 44 degrades beyond a preset threshold. The current/voltage controller circuit 74 may be embedded in an addition optional layer of material disposed within the mask, or in the same layer as UV LEDs 44 provided controller 74 does not materially interfere the flow of air. Mode selector switch 70 may be located anywhere convenient on the outer shell of the mask.

FIG. 7 illustrates one example of possible operation of the control system illustrated in FIG. 6. The top graph in FIG. 7 is a plot of air pressure as a function of time during normal breathing. Two inhales 80 and one exhale 82 are illustrated in FIG. 7. The bottom graph illustrates drive current supplied to UV LEDs 44 as a function of time. As is clear from the bottom graph, no drive current is supplied to UV LEDs 44 during exhale 82, indicating that mode selector 70 is set to active UV LEDs 44 only during the inhale portion of the breathing cycle. When the air pressure at sensor 72 indicates that the wearer is inhaling, controller 74 may activate some or all of the UV LEDs 44 in the flow chamber. In the operation illustrated in FIG. 7, controller 74 supplies drive current that is proportional to the air pressure. When air pressure reaches a peak 84 during the wearer's inhale, drive current supplied to UV LEDs 44 also reaches a peak 86. The proportional current/voltage output of the circuit can be achieved by amplifying pressure sensor signals (either current or voltage) by using current or voltage amplifiers commonly used in the electronics industry.

Other functions such as digital recording play-back capabilities, decorative components, indicators, or fabrics maybe added to the breathing apparatus.

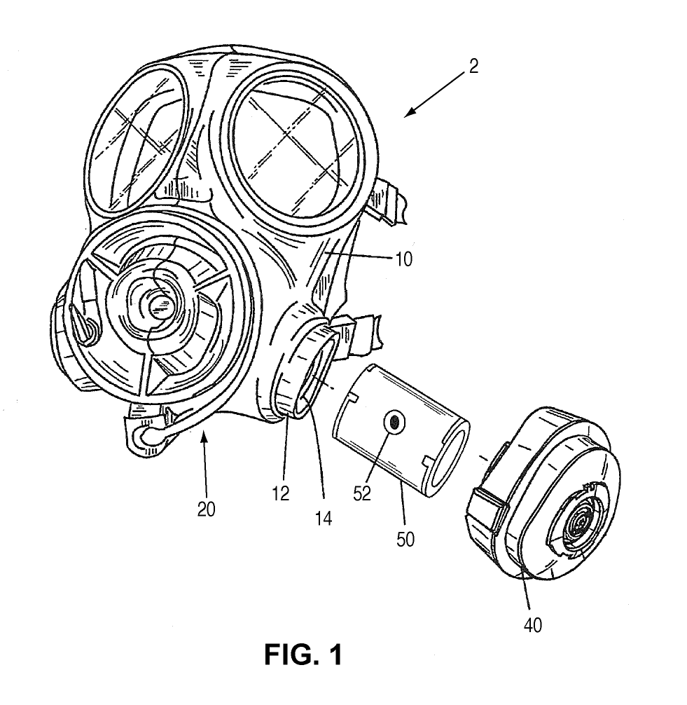

The examples described above may offer advantages over conventional facemasks and the protection mask illustrated in FIG. 1. Embodiments of the invention provide direct air disinfection, which may be more effective at reducing the risk of respiratory infection, as compared to a conventional facemask. In embodiments of the invention, the flow chamber is not blocked with one or more layers of fabrics like a mechanical air filter. Also, unlike the protection mask illustrated in FIG. 1, embodiments of the invention do not require a completely sealed, face-tight fit in order to be effective. Accordingly, embodiments of the invention may be more comfortable for the wearer which may encourage use of the breathing apparatus, even during hot and humid weather.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is being claimed is:

1. A breathing apparatus comprising:
a facemask portion sized to cover a lower portion of a wearer's face, the facemask portion comprising:
a flow chamber defined by a support layer and a cover, the flow chamber comprising a first opening disposed near a first end of the flow chamber and a second opening disposed near a second end of the flow chamber; and
at least one light emitting diode configured to emit light having a peak wavelength in the ultraviolet range disposed between the first opening and the second opening in the flow chamber.

2. The breathing apparatus of claim 1 wherein the at least one light emitting diode is attached to the support layer.

3. The breathing apparatus of claim 1 wherein the flow chamber further comprises structures configured to create turbulence in fluid flowing through the flow chamber.

4. The breathing apparatus of claim 1 wherein the flow chamber comprises a plurality of serpentine passages.

5. The breathing apparatus of claim 1 further comprising an ultraviolet-reflective material disposed on at least a portion of an inside surface of the flow chamber.

6. The breathing apparatus of claim 1 wherein the flow chamber further comprises a plurality of ultraviolet-reflective chambers, wherein a light emitting diode configured to emit light having a peak wavelength in the ultraviolet range is disposed in each ultraviolet-reflective chamber.

7. The breathing apparatus of claim 1 further comprising:
a sensor, wherein the sensor is configured to detect one of a pressure and a flow rate of air through the flow chamber; and
a controller coupled to the sensor and the at least one light emitting diode, wherein the controller is configured to supply current to the at least one light emitting diode based on information received from the sensor.

8. The breathing apparatus of claim 7 wherein the controller is configured to supply current to the at least one light emitting diode that is proportional to an amount of pressure or flow rate detected by the sensor.

9. The breathing apparatus of claim 7 wherein the controller is configured to supply current to the at least one light emitting diode when the sensor detects that fluid is flowing through the flow chamber from the first opening to the second opening and to supply no current to the at least one light emitting diode when the sensor detects that fluid is flowing through the flow chamber from the second opening to the first opening.

10. The breathing apparatus of claim 7 further comprising a mode selector, where the mode selector is configured to select one of the following modes:
the controller supplies current to the at least one light emitting diode only when the sensor detects that fluid is flowing through the flow chamber from the first opening to the second opening;
the controller supplies current to the at least one light emitting diode only when the sensor detects that fluid is flowing through the flow chamber from the second opening to the first opening; and
the controller supplies current to the at least one light emitting diode both when the sensor detects that fluid is flowing through the flow chamber from the first opening to the second opening and when the sensor detects that fluid is flowing through the flow chamber from the second opening to the first opening.

11. The breathing apparatus of claim 1 further comprising:
a power supply;
a structure for securing the facemask portion to a wearer's face; and
electrical wires connecting the power supply to the at least one light emitting diode, wherein the electrical wires are disposed within the structure.

12. A method comprising:
detecting air flow through a flow chamber of a facemask sized to cover a lower portion of a wearer's face, the flow chamber comprising a first opening disposed near a first end of the flow chamber and a second opening disposed near a second end of the flow chamber, the flow chamber comprising at least one light emitting diode configured to emit light having a peak wavelength in the ultraviolet range disposed between the first opening and the second opening in the flow chamber; and
supplying current to the at least one light emitting diode based on the air flow detected.

13. The method of claim 12 wherein:
detecting air flow comprises detecting flow rate of air; and
supplying current comprises supplying an amount of current that is proportional to the detected flow rate of air.

14. The method of claim 12 wherein:
detecting air flow comprises detecting direction of the air flow; and
supplying current comprises supplying current based on the detected direction of air flow.
